(19) United States
(12) Patent Application Publication
(10) Pub. No.: US 2011/0095214 A1
(43) Pub. Date: Apr. 28, 2011

(54) Automatic water flushing device for floor toilet

(76) Inventor: Hsiang Hung Wang, Changhua Hsien (TW)

(21) Appl. No.: 12/589,584

(22) Filed: Oct. 26, 2009

(51) Int. Cl. F16K 31/02

(52) U.S. Cl. 251/129.01

(57) ABSTRACT

A water flushing device includes a membrane engaged onto a housing, a cover engaged with the membrane for forming a compartment between the membrane and the cover, a valve device engaged with the membrane for opening and blocking the opening of the membrane and having a passage, a valve element slidably disposed between the valve device and the cover for selectively blocking the passage of the valve device, a control device includes a motor having a spindle coupled to an arm, and a magnetic member attached to the arm and moveable toward or away from the valve element for actuating the valve element to selectively open or block the passage of the valve device.

### BACKGROUND OF THE INVENTION

1. Field of the Invention

The present invention relates to a water flushing device for a floor toilet, and more particularly to an automatic water flushing device for a floor toilet including a sensing or detecting device for detecting whether a user is using the floor toilet or not and for automatically flushing the water after using the floor toilet.

2. Description of the Prior Art

Typical water flushing devices for the floor toilets comprise a housing disposed on the floor and coupled to a water reservoir for receiving the water from the water reservoir, the housing including an outlet port directed or coupled to the floor toilet bowl, a valve device disposed in the housing for controlling the water to selectively flow from the housing to the floor toilet bowl, and an actuating handle or lever coupled to the valve device for actuating or operating the valve device to control the water to flow from the housing to the floor toilet bowl.

Normally, the valve device is required to be actuated or operated by the users manually, such as by the hands or the feet of the users in order to open the water flowing passage in the housing when required; i.e., the valve devices for the typical floor toilets may not be actuated or operated automatically without being contacted or actuated or operated by the users.

However, when provided in the public locations, dirt or germs or other contaminant may be transferred from people to people and the diseases may have a good chance to be widely infected in the public.

The present invention has arisen to mitigate and/or obviate the afore-described disadvantages of the conventional water flushing devices for the floor toilets.

### SUMMARY OF THE INVENTION

The primary objective of the present invention is to provide a water flushing device including a sensing or detecting device for detecting whether a user is using the floor toilet or not and for automatically flushing the water after using the floor toilet.

The other objective of the present invention is to provide a water flushing device including a structure for easily and readily attaching or mounting onto the typical manually operated water flushing device for the floor toilet without changing the configuration or structure of the typical manually operated water flushing device for the floor toilet.

In accordance with one aspect of the present invention, there is provided a water flushing device comprising a housing including an inlet port for receiving water, and including an outlet port, a membrane including an outer peripheral portion engaged onto an upper portion of the housing for blocking the upper portion of the housing, and including an opening formed therein, a cover engaged onto the upper portion of the housing and engaged with the membrane for forming a compartment above the membrane and between the membrane and the cover, a valve device engaged with the membrane for selectively opening and blocking the opening of the membrane, and including a passage formed therein, a valve element slidably disposed between the valve device and the cover for selectively engaging with the valve device and for selectively blocking the passage of the valve device, the valve element including a first magnetic member, a control device including a motor having a spindle coupled to an arm, and a second magnetic member attached to the arm and moveable toward or away from the first magnetic member of the valve element for actuating or operating the valve element to selectively open or block the passage of the valve device.

The valve element includes a resilient pad provided thereon for engaging with the valve device and for selectively blocking and sealing the passage of the valve device. The control device includes a detecting device for detecting whether a user is using the floor toilet or not and for automatically flushing the water after using.

The control device includes a receptacle attached onto the upper portion of the housing and having an aperture formed therein for engaging with the detecting device.

The control device includes a spring biasing member engaged between the valve device and the valve element for disengaging the valve element from the valve device and for opening the passage of the valve device, the second magnetic member is used to act with the first magnetic member of the valve element and to actuate and operate and move the valve element to selectively block the passage of the valve device.

The control device includes a spring biasing member engaged between the cover and the valve element for biasing the valve element to engage with the valve device and to block the passage of the valve device, the second magnetic member is used to act with the first magnetic member of the valve element and to actuate and operate and move the valve element to selectively open the passage of the valve device.

The housing includes a casing extended in the housing for forming an outer peripheral space between the housing and the casing, and for forming a bore within the casing, and the outer peripheral space formed and located between the housing and the casing is communicative with the inlet port for receiving the water from the inlet port, a barrel is disposed in the casing and attached to the membrane and includes a bore formed therein and communicative with the opening of the membrane, the valve device includes a stem extended through the opening of the membrane and into the bore of the barrel.

An actuating device may further be provided and attached and secured to the housing and includes an actuating rod extended into the housing and engageable with the stem of the valve device for selectively tilting the stem and the valve device relative to the barrel, and includes an actuating lever extended out of the housing for operating the actuating rod.

The membrane includes at least one gasket engaged into and through the membrane, and the gasket includes an orifice formed therein for allowing the water to flow through the orifice of the gasket and to selectively flow through the membrane.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a water flushing device in accordance with the present invention;

FIG. 2 is a partial exploded view of the water flushing device;

FIG. 3 is another perspective view illustrating a control device of the water flushing device;

FIG. 4 is a further perspective view illustrating a valve element of the water flushing device;

FIG. 5 is a partial cross sectional view of the water flushing device;

FIG. 6 is another partial cross sectional view similar to FIG. 5, illustrating the operation of the water flushing device; and

FIGS. 7 and 8 are partial cross sectional views similar to FIGS. 5 and 6 illustrating the other arrangement of the water flushing device.

### DETAILED DESCRIPTION OF THE PREFERRED EMBODIMENT

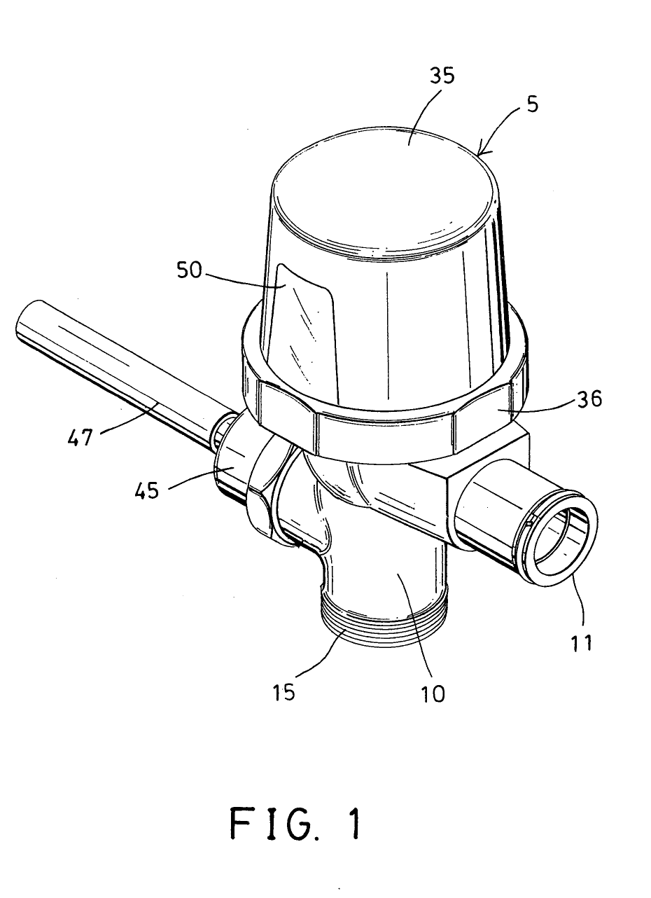

Referring to the drawings, and initially to FIGS. 1-2 and 5-6, a water flushing device in accordance with the present invention comprises a housing 10 for being disposed on the floor (not shown), and including an inlet port 11 for coupling to a water reservoir (not shown) and for receiving the water from the water reservoir, the housing 10 includes a cylindrical casing 12 extended in the housing 10 for forming an outer peripheral space 13 between the housing 10 and the casing 12, and for forming a chamber 14 within the casing 12, and the outer peripheral space 13 formed and located between the housing 10 and the casing 12 is communicative with the inlet port 11 for receiving the water from the inlet port 11, the housing 10 includes an outlet port 15 directed or coupled to the floor toilet bowl (not shown) for selectively supplying the water to the floor toilet bowl.

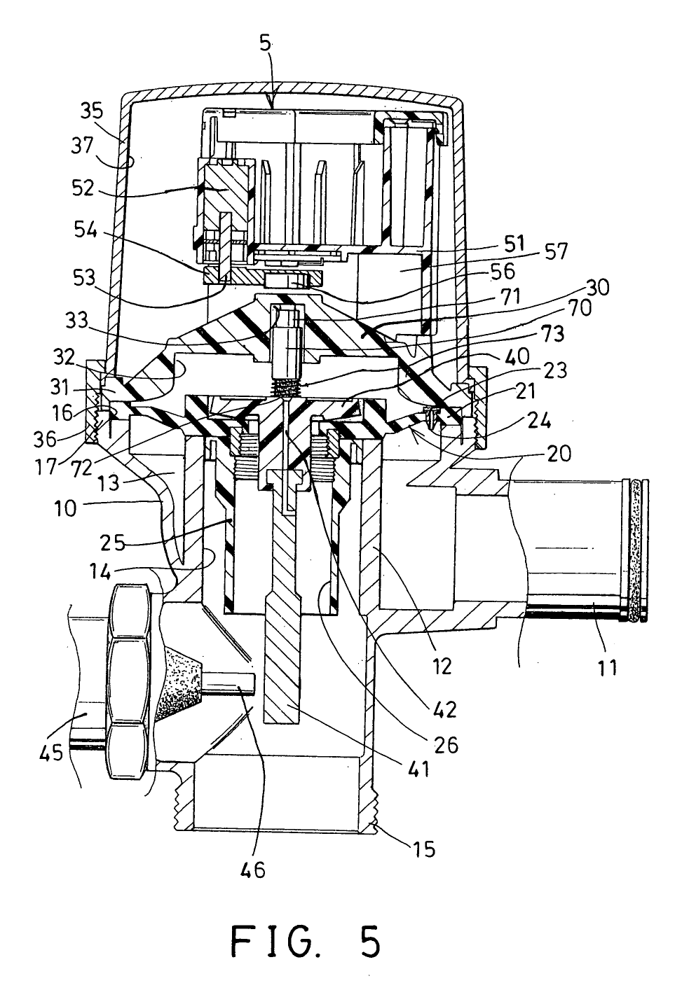

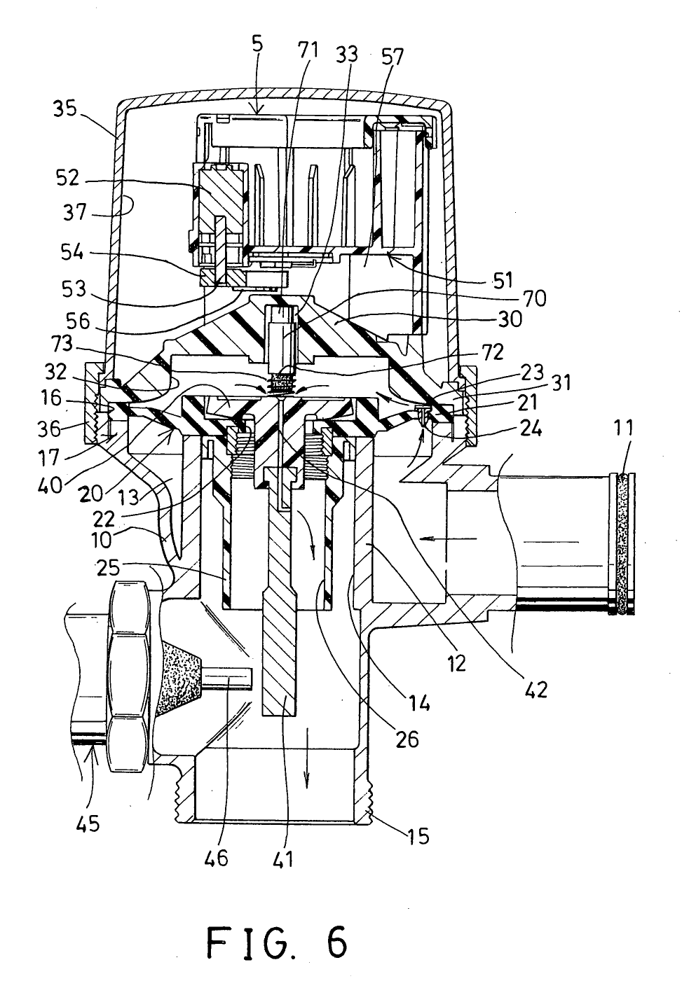

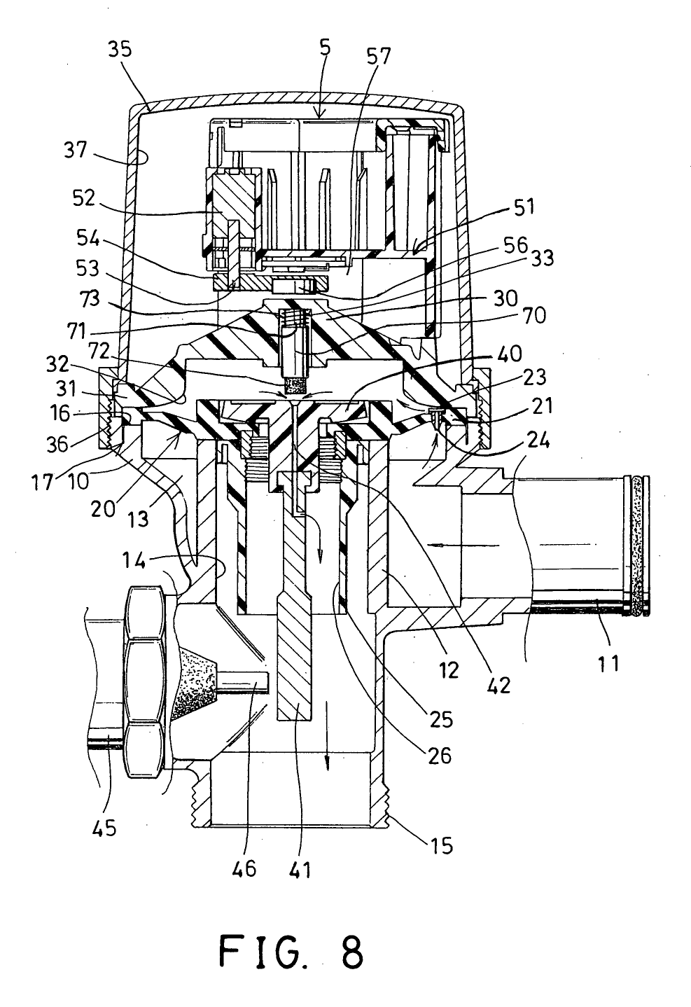

The housing 10 further includes an inner peripheral shoulder 16 formed in the upper portion 17 thereof and located above or higher than the upper portion of the casing 12 (FIGS. 5-8). As shown in FIGS. 1-6 and 9-10, a soft or resilient film or membrane 20 includes an outer peripheral portion 21 engaged onto or into the peripheral shoulder 16 or the upper portion 17 of the housing 10 for blocking or sealing the upper portion of the housing 10 and/or the casing 12, and includes a center opening 22 formed therein. One or more plugs or gaskets 23 are engaged into or through the membrane 20, and the gaskets 23 each include an orifice 24 formed therein for allowing the water to flow through the orifices 24 of the gaskets 23 and to selectively flow through the membrane 20 (FIGS. 6 and 8) and to flow from the outer peripheral space 13 of the housing 10 to the upper portion of the membrane 20.

A barrel 25 is disposed or engaged in the chamber 14 of the casing 12 and attached or mounted or secured to the membrane 20, and includes a bore 26 formed therein and communicative with the opening 22 of the membrane 20, and arranged for allowing the water to flow from the outer peripheral space 13 of the housing 10 through the orifices 24 of the gaskets 23 and the membrane 20, and then to selectively flow into the opening 22 of the membrane 20 and the bore 26 of the barrel 25, and then to selectively flow out through the outlet port 15 of the housing 10. A cover 30 is engaged onto the upper portion 17 of the housing 10 and includes an outer peripheral flange 31 engaged with the outer peripheral portion 21 of the membrane 20 for forming or defining a sealed compartment 32 above the membrane 20 or between the membrane 20 and the cover 30, and includes a cavity 33 formed therein and communicative with the sealed compartment 32 that is formed between the membrane 20 and the cover 30.

A valve device 40 is disposed above or higher than the upper portion of the membrane 20 and engageable with the membrane 20 for selectively blocking or sealing the opening 22 of the membrane 20, and for controlling the water to flow from the compartment 32 of the cover 30 into or through the opening 22 of the membrane 20 and the bore 26 of the barrel 25. The valve device 40 includes a stem 41 extended downwardly therefrom and extended into or through the opening 22 of the membrane 20 and the bore 26 of the barrel 25, and the opening 22 of the membrane 20 may be selectively opened when the stem 41 of the valve device 40 is tilted relative to the membrane 20 and the barrel 25, and may be selectively blocked by the valve device 40 when the stem 41 of the valve device 40 is not tilted relative to the membrane 20 and the barrel 25.

The valve device 40 includes a passage 42 formed therein and/or formed through the stem 41 and arranged for allowing the water to selectively flow from the compartment 32 of the cover 30 into or through the passage 42 of the stem 41 or of the valve device 40, and then to flow through the bore 26 of the barrel 25. The water may flow from the compartment 32 of the cover 30 into or through the passage 42 of the stem 41 or of the valve device 40 only when the passage 42 of the stem 41 or of the valve device 40 is opened, and may not flow into or through the passage 42 of the stem 41 or of the valve device 40 when the passage 42 of the stem 41 or of the valve device 40 is blocked by a slidable valve element 70 or the like which will be described hereinafter.

A manual actuating device 45 is attached or secured to the housing 10, and includes an actuating rod 46 extended into the housing 10 and engageable with the stem 41 of the valve device 40 for selectively tilting the stem 41 and the valve device 40 relative to the membrane 20 and the barrel 25, and thus for selectively opening the opening 22 of the membrane 20 and thus for allowing the water to be controlled to flow from the compartment 32 of the cover 30 into or through the opening 22 of the membrane 20 and the bore 26 of the barrel 25. The manual actuating device 45 includes an actuating handle or lever 47 coupled thereto and extended out of the housing 10 for actuating or operating the actuating rod 46 to selectively tilt the stem 41 and the valve device 40 relative to the membrane 20 and the barrel 25 and for allowing the valve device 40 to be actuated or operated by the users manually, when required, in which the above-described structure of the actuating rod 46 and the actuating handle or lever 47 of the manual actuating device 45 is typical and is not related to the present invention and will not be described in further details.

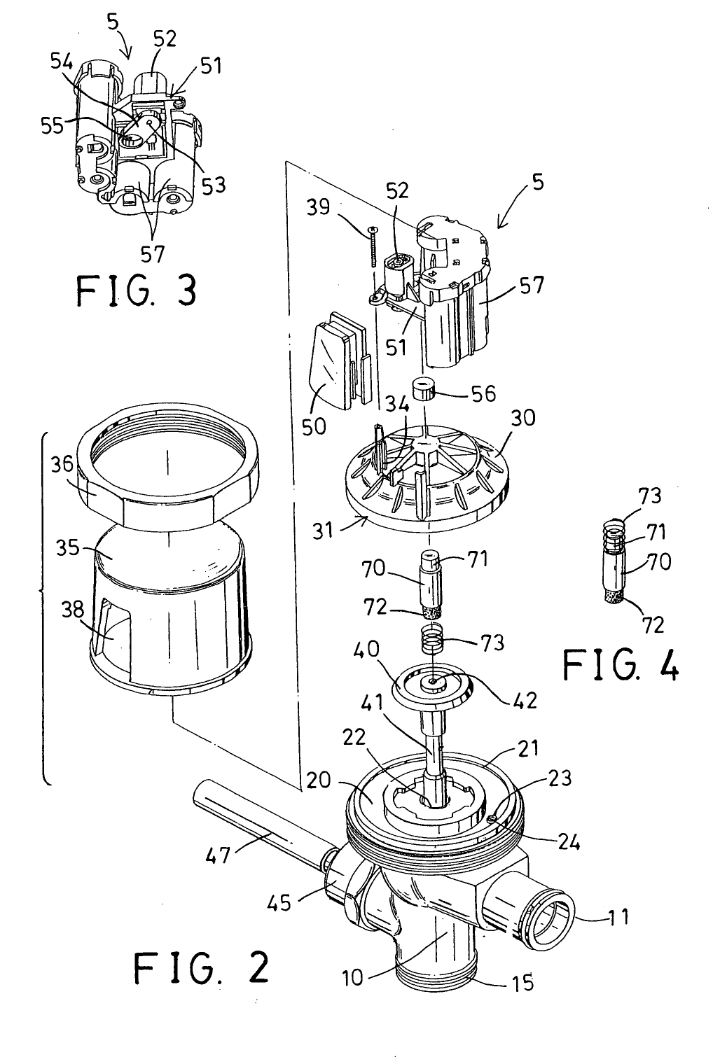

A receptacle 35 is further provided and engaged onto the cover 30, such as engaged onto the outer peripheral flange 31 of the cover 30, and attached or mounted or secured to the upper portion 17 of the housing 10 with a lock nut 36 or other securing members or devices, and includes a chamber 37 formed in the receptacle 35, and further includes an aperture 38 formed in the receptacle 35 and communicative with the chamber 37 of the receptacle 35. A control assembly 5 is further provided and disposed or engaged into the receptacle 35, and includes a sensing or detecting device 50, such as an infrared sensing or detecting device 50 attached to the receptacle 35, such as engaged in the aperture 38 of the receptacle 35 and/or attached or mounted or secured to an anchoring seat 34 of the cover 30 (FIG. 2) for sensing or detecting whether a user is using the floor toilet or not and for automatically actuating or flushing the water after using the floor toilet.

The control assembly 5 includes a circuit board or processing or control device 51 disposed or engaged into the receptacle 35 and attached or mounted or secured to the cover 30 with one or more fasteners 39 (FIG. 2) and coupled to the detecting device 50, and includes a motor 52, such as a step motor 52 attached or mounted or secured to the control device 51 and having a spindle 53 coupled to an arm 54 (FIG. 3) for rotating the arm 54 relative to the control device 51, the arm 54 includes an orifice 55 formed therein for receiving or engaging with a magnetic member 56 therein. The control device 51 of the control assembly 5 is provided for actuating or controlling the valve element 70 to selectively open or block the passage 42 of the stem 41 or of the valve device 40, and includes one or more batteries 57 attached thereto for energizing the control device 51, the motor 52, the sensing or detecting device 50, and the other electrical parts or elements.

As shown in FIGS. 2 and 5-6, the valve element 70 includes a magnetic member 71 mounted or provided thereon, such as provided on the upper portion thereof for engaging with or for acting with the magnetic member 56 and for moving the valve element 70 relative to the cover 30 and the valve device 40 and for actuating or operating or moving the valve element 70 to selectively open or block the passage 42 of the stem 41 or of the valve device 40. The valve element 70 includes a flexible or soft or resilient end or pad 72 formed or provided thereon, such as provided on the lower portion thereof for engaging with the valve device 40 and for selectively and suitably blocking the passage 42 of the stem 41 or of the valve device 40 (FIG. 5).

A spring biasing device or member 73 may further be provided and engaged onto or engaged with the valve device 40 and the valve element 70, or engaged between the valve device 40 and the valve element 70 for suitably spacing or disengaging the pad 72 of the valve element 70 from the valve device 40 and for suitably opening the passage 42 of the stem 41 or of the valve device 40, and thus for allowing the water to selectively flow from the compartment 32 of the cover 30 into or through the passage 42 of the stem 41 or of the valve device 40. The magnetic member 56 may normally be moved to align with the magnetic member 71 of the valve element 70 by the motor 52 and controlled with the control device 51, in order to force the valve element 70 to move onto the spring biasing member 73 and to force the pad 72 of the valve element 70 to engage with the valve device 40 and to selectively and suitably block the passage 42 of the stem 41 or of the valve device 40 (FIG. 5).

When it is required to flush water or to open the passage 42 of the stem 41 or of the valve device 40, the control device 51 may actuate or operate the motor 52 to rotate the arm 54 and to move or disengage the pad 72 of the valve element 70 from the valve device 40 and for suitably opening the passage 42 of the stem 41 or of the valve device 40 (FIG. 6), and thus for allowing the water to selectively flow from the compartment 32 of the cover 30 into or through the passage 42 of the stem 41 or of the valve device 40.

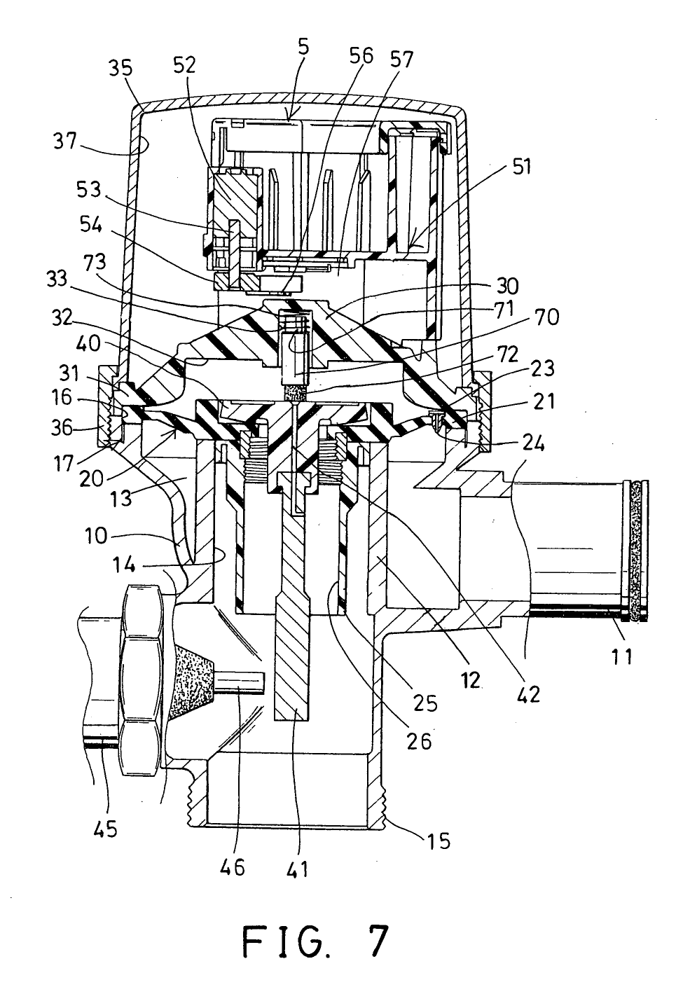

Alternatively, as shown in FIGS. 4 and 7-8, the spring biasing member 73 may also be attached or mounted or engaged onto the magnetic member 71 of the valve element 70 or engaged between the cover 30 and the valve element 70 for suitably biasing or forcing the pad 72 of the valve element 70 to engage with the valve device 40 and to selectively and suitably block the passage 42 of the stem 41 or of the valve device 40 (FIG. 7). When it is required to flush water or to open the passage 42 of the stem 41 or of the valve device 40, the control device 51 may actuate or operate the motor 52 to rotate the arm 54 and to move or align the magnetic member 56 with the magnetic member 71 of the valve element 70 in order to attract or move or disengage the pad 72 of the valve element 70 from the valve device 40 and for suitably opening the passage 42 of the stem 41 or of the valve device 40 (FIG. 8), and thus for allowing the water to selectively flow from the compartment 32 of the cover 30 into or through the passage 42 of the stem 41 or of the valve device 40.

In operation, the stem 41 of the valve device 40 may be selectively tilted relative to the membrane 20 and the barrel 25 with the actuating rod 46 and the actuating handle or lever 47 of the actuating device 45 in order to selectively open the opening 22 of the membrane 20 and to allow the water to flow out through the outlet port 15 of the housing 10 and thus for allowing the water to be controlled manually to flow from the compartment 32 of the cover 30 into or through the opening 22 of the membrane 20 and the bore 26 of the barrel 25. The sensing or detecting device 50 may also be used to sense or detect whether a user is using the floor toilet or not and may be used to automatically actuate or flush the water after using the floor toilet.

It is to be noted that the receptacle 35 and the processing or control device 51 of the control assembly 5 may be easily and readily attached or mounted onto the typical manually operated water flushing device for the floor toilet without changing the configuration or structure of the typical manually operated water flushing device for the floor toilet.

Accordingly, the water flushing device in accordance with the present invention includes a sensing or detecting device for detecting whether a user is using the floor toilet or not and for automatically actuating or flushing the water after using the floor toilet.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water flushing device comprising:
a housing including an inlet port for receiving water, and including an outlet port,
a membrane including an outer peripheral portion engaged onto an upper portion of said housing for blocking said upper portion of said housing, and including an opening formed therein,
a cover engaged onto said upper portion of said housing and engaged with said membrane for forming a compartment above said membrane and between said membrane and said cover,
a valve device engaged with said membrane for selectively opening and blocking said opening of said membrane, and including a passage formed therein,
a valve element slidably disposed between said valve device and said cover for selectively engaging with said valve device and for selectively blocking said passage of said valve device, said valve element including a first magnetic member,
a control device including a motor having a spindle coupled to an arm, and a second magnetic member attached to said arm and moveable toward or away from said first magnetic member of said valve element for actuating said valve element to selectively open or block said passage of said valve device.

2. The water flushing device as claimed in claim 1, wherein said valve element includes a resilient pad provided thereon for engaging with said valve device and for selectively blocking said passage of said valve device.

3. The water flushing device as claimed in claim 1, wherein said control device includes a detecting device for detecting a user.

4. The water flushing device as claimed in claim 3, wherein said control device includes a receptacle attached onto said upper portion of said housing and having an aperture formed therein for engaging with said detecting device.

5. The water flushing device as claimed in claim 1, wherein said control device includes a spring biasing member engaged between said valve device and said valve element for disengaging said valve element from said valve device and for opening said passage of said valve device, said second magnetic member is used to act with said first magnetic member of said valve element and to actuate and operate and move said valve element to selectively block said passage of said valve device.

6. The water flushing device as claimed in claim 1, wherein said control device includes a spring biasing member engaged between said cover and said valve element for biasing said valve element to engage with said valve device and to block said passage of said valve device, said second magnetic member is used to act with said first magnetic member of said valve element and to actuate and operate and move said valve element to selectively open said passage of said valve device.

7. The water flushing device as claimed in claim 1, wherein said housing includes a casing extended in said housing for forming an outer peripheral space between said housing and said casing, and for forming a bore within said casing, and said outer peripheral space formed and located between said housing and said casing is communicative with said inlet port for receiving said water from said inlet port, a barrel is disposed in said casing and attached to said membrane and includes a bore formed therein and communicative with said opening of said membrane, said valve device includes a stem extended through said opening of said membrane and into said bore of said barrel.

8. The water flushing device as claimed in claim 7, wherein an actuating device is attached and secured to said housing and includes an actuating rod extended into said housing and engageable with said stem of said valve device for selectively tilting said stem and said valve device relative to said barrel, and includes an actuating lever extended out of said housing for operating said actuating rod.

9. The water flushing device as claimed in claim 1, wherein said membrane includes at least one gasket engaged into and through said membrane, and said at least one gasket includes an orifice formed therein for allowing the water to flow through said orifice of said at least one gasket and to selectively flow through said membrane.
